(19) United States
(12) Patent Application Publication
(10) Pub. No.: US 2009/0285870 A1
(43) Pub. Date: Nov. 19, 2009

(54) ANTIFUNGAL/ANTIBACTERIAL AGENT COMPRISING TWO-STEP BAKED SHELL POWDER

(75) Inventors: Eiichi Narita, Siwa-gun (JP); Tokuichi Sato, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: Nippon Natural Resource Co., Ltd., Chuo-ku, Tokyo (JP)

(21) Appl. No.: 12/095,448

(22) PCT Filed: Nov. 27, 2006
(86) PCT No.: PCT/JP2006/324125

§ 371 Date: Jun. 4, 2009

(30) Foreign Application Priority Data
Nov. 30, 2005 (JP) 2005-345053

(51) Int. Cl. A01N 25/12; A01N 59/06

(52) U.S. Cl. 424/405; 424/687

(57) ABSTRACT

An antimold/antibacterial agent characterized by comprising a baked shell powder which is obtained by washing shells with water, drying, roughly crushing, baking the crushed matter in a non-oxidizing atmosphere at a low temperature of 500 to 600° C. and then in the air atmosphere at a medium temperature of 600 to 900° C., and pulverizing the baked shells to preferably an average particle size of 40 μm or less. By the two-step baking treatment, an inorganic composite powder in which a small amount of calcium oxide is scattered in porous calcite-type calcium carbonate can be obtained, and thanks to its porosity and synergetic action between calcium carbonate and calcium oxide, the powder can exhibit excellent and long-lasting antimold/antibacterial effects.

### TECHNICAL FILED

The present invention relates to an antimold/antibacterial agent comprising two-step baked shell powder. More specifically, the invention relates to an inorganic complex-based antimold agent comprising shell powder obtained by subjecting crudely crushed scallop shells consisting mainly of calcite-type calcium carbonate to two-step baking treatment while changing baking atmosphere and then pulverizing the crushed shells.

The antimold agent of the present invention, when blended in a small amount in material such as synthetic resin, synthetic rubber, wood-based plywood, nonwoven textile or paper, can suppress proliferation of fungi such as black mold, red mold, blue mold, Alternaria and aspergillus in an effective and enduring manner.

### BACKGROUND ART

Amid the recently increasing needs for healthy and comfortable life, demands for bacteria elimination and antimicrobial material are also rising, which has led to developments of many bactericidal agents and antimold agents. Among commercially available conventional bactericidal agents and antimold agents, there are many products confusing antibacterial effect with antimold effect and featuring both antibacterial and antimold effects. Bacteria are, however, biologically different from molds, and an antibacterial agent does not always have an antimold effect. (Atsushi Nishino et al., “Kokinzai no Kagaku I” (Science of antimold agent), Kogyo Chosakai Publishing, INC. (1996); Mayumi Inoue, “Kabi to Kenko no Joshiki Hijoshiki” (common knowledge and misconception about molds and health), NIPPON JITUGYO PUBLISHING (2006)) Apart from antibacterial agent, there is a rising demand for a safe antimold agent which is effective against molds.

Molds are necessary for food processing and miso (soybean paste), shoyu (soy sauce), katsuobushi (dried bonito flakes), sake, wine, cheese, natto, pickles and the like cannot be produced without molds. On the other hand, molds do various harms such as food poisoning, skin diseases and contamination of food, building materials, house furnishings, household products, clothes and the like. Moreover, molds getting on synthetic resin or synthetic rubber or medical materials, child-care products, nursing-care products or electronic products using synthetic resin or rubber have been known recently and developments of mold removers for eliminating mold and antimold agents for suppressing growth and proliferation of molds are being vigorously made. [Shigeharu Ueda, Supervising editor: Atsuhi Nishino, “Kokin Kokabi no Saishingijutsu to DDS no Jissai” (Current antibacterial/antimold technique and DDS practice), NTS Inc. (2005)]

As conventional mold removers, those containing hypochlorous acid which has highly oxidative property are known. This substance is not safe in that it has an odor very irritating to eyes and noses. Moreover, its effect of preventing growth of mold is weak and it cannot be mixed with other solid materials. On the other hand, among antimold agents widely used currently, inorganic-type agents and organic-type agents are known.

As inorganic-type antimold agents, composite materials in which metals (such as silver, copper and zinc) are bonded to zeolite, silica gel, ceramics and the like have been developed. Those materials, however, have many disadvantages: antimold effect is low; properties are easily modified by light or heat-sensitive; they are reactive with halogen; toxicity of metal ingredients is of concern; and such a material is difficult to be compounded with other materials. In addition, those containing metal oxide as the main ingredient are also known as inorganic-type antimold agents. This type is, however, also generally low in its antimold effect although it exhibits antibacterial effect. It is disadvantageous in the following points: when the metal oxide is calcium oxide or magnesium oxide, the property is strong alkaline and unstable and the effects of the agent cannot be sustainable; when the metal oxide is zinc oxide, toxicity of the metal is of concern; when the metal oxide is titanium oxide, the effect cannot be exhibited without light; and composite matrix material is decomposed.

On the other hand, as organic-type antimold agents, organic compounds such as thiabendazole, Preventol (registered trademark), vinyzene, carbendazin and captan have been developed, which have high antimold effect and are being widely used. These compounds, which are organic, are disadvantageous in that they can be easily affected by heat, temperature, light and the like and that they lack stable properties. Especially, the low heat resistance is significantly disadvantageous, considering that blending with synthetic resin or synthetic rubber is usually carried out at a high temperature of 150 to 350° C.

In particular, although organic-type synthetic antimold agents have high antimold effects, they have sublimation and degradation properties, which may adversely affect the human body, depending on how the agent is used. In case of natural-type organic materials, antimold effect is generally low and not satisfactorily sustainable and furthermore, such materials have volatile, eluting and/or degradable properties, which may adversely affect the human health as well. For example, care must be taken when the antimold agent contains antibacterial ingredients derived from wasabi or mustard readily become gases, which may be harmful to human health not only through skin but also through respiratory system.

In contrast to conventional inorganic-type antimold agents using metal or metal oxide, antibacterial agents or antimold agents using natural material of baked shell powder have been proposed recently. For example, it is proposed to use calcium oxide obtained by baking crushed scallop shells at a high temperature of 1000° C. or higher in antifungal agents, agents for decomposing ingredients causing sick house syndrome, deodorizers and the like (Japanese Patent Application Laid-Open No. 2001-145693). Antimold property, however, has not been shown in such a technique although there is a report that calcium oxide obtained by baking crushed scallop shells at a high temperature of 1000° C. or higher can exhibit an antibacterial effect of the same level with that of calcium oxide reagent (J. Sawai et al., J. Food Prot., vol 66, p 1482, 2003). Also, an antibacterial/antimold agent comprising calcium oxide powder with an average particle size of 5 μm or less which is obtained by baking surf clam shells at 900° C. has been known (Japanese Patent Application Laid-Open No. 2001-278712).

Thus, the technique of using powder of calcium oxide obtained by baking shells at a temperature of about 1000° C. has been conventionally known. In such a conventional baked shell powder, which is obtained by baking shells at a high temperature until they become calcium oxide, its antibacterial effect is only temporary and cannot be sustained. Moreover, as described above, bacteria and molds are biologically different from each other, and the conventional technique can exhibit an antibacterial effect but its antimold effect is low.

In addition, production of shell powder consisting of calcium carbonate and calcium oxide with an average particle size of 0.1 to 100 μm obtained by baking shells at 600 to 1000° C. is known (Japanese Patent Application Laid-Open No. 2002-220227). This baked shell powder is known to have an action of decomposing dioxin and formaldehyde, but it is not clear whether or not the powder includes antibacterial effect and antimold effect.

On the other hand, bacteria controlling agent consisting of baked shell powder with an average particle size of 10 μm or less obtained by baking scallop shells at 600 to 700° C. is known (Japanese Patent Application Laid-Open No. 2002-255714). Although the document refers to antimold property of the agent, no specific antimold effect is described.

Thus, it has been conventionally known to use baked shell powders obtained by baking shells at 1000° C. or higher or at about 600° C. as antibacterial agents or antimold agents. These baked shell powders are all obtained by simply baking shells in the air and therefore, the antibacterial effects of calcium oxide are not sustainable and the antimold effects are not always sufficient.

### DISCLOSURE OF INVENTION

The present invention solves the above problems in conventional antimold agents consisting of baked shell powders. The invention provides an inorganic-type antimold agent having a sustainable and excellent antimold effect, easily produced from highly safe natural shells as raw materials without using special chemicals or special technique, which can be disposed of in an eco-friendly manner.

The antimold/antibacterial agent of the present invention is as follows.

(1) An antimold/antibacterial agent, comprising inorganic composite baked powder having a structure where a small amount of calcium oxide is contained inside a porous body of calcium carbonate, which agent is obtained by subjecting shells to washing with water, drying and crushing treatments and then baking the crushed shells first at a low temperature in non-oxidizing atmosphere and secondly at a medium temperature in the air atmosphere, followed by pulverization.
(2) The antimold/antibacterial agent according to (1), wherein the molar ratio of carbonate to calcium (CO₃/Ca) is in a range of 0.90 to 0.95.
(3) The antimold/antibacterial agent according to (1) or (2), wherein the temperature employed at first-step baking treatment carried out in non-oxidizing atmosphere is in a range of 500 to 600° C. and the temperature employed at second-step baking treatment carried out in the air atmosphere is in a range of 600 to 900° C.
(4) The antimold/antibacterial agent according to any one of (1) to (3), which is obtained by subjecting the shells to washing, drying and crushing treatments and then baking the crushed shells first at a low temperature of 500 to 600° C. in non-oxidizing atmosphere and secondly at a medium temperature of 600 to 900° C. in the air atmosphere, followed by pulverization of the crushed shells to thereby obtain a fine powder having an average particle size of 40 μm or less.
(5) The antimold/antibacterial agent according to any one of (1) to (4), wherein the particle size is within a range of 0.5 to 10 μm and the specific surface area is within a range of 10 to 30 m²/g.
(6) The antimold/antibacterial agent according to any one of (1) to (5), wherein the shell is one or more kinds selected from a group consisting of scallop, oyster, surf clam, abalone, blue mussel, little clam and clam.

The antimold/antibacterial agent of the present invention consists of inorganic composite baked powder where a small amount of calcium oxide is scattered in porous calcite-type calcium. With synergic action between calcium carbonate and calcium oxide in the porous body, it can exhibit excellent antimold/antibacterial effects. It can be confirmed by X-ray diffraction analysis that X-ray diffraction pattern of the small amount of the calcium oxide is present together with the diffraction pattern of the calcite.

By dissolving the antimold agent powder in aqueous solution of hydrochloric acid, carbon dioxide gas is allowed to generate and is subjected to quantitative analysis. Then the result is converted into CO₃²⁻ ion amount and further, the Ca²⁺ ion amount in the aqueous solution of hydrochloric acid is analyzed by atomic absorption spectrophotometer and the molar ratio (CO₃/Ca) calculated is within a range of 0.90 to 0.95. Based on this result, it is confirmed that the powder agent mainly comprises calcium carbonate and also contains a small amount of calcium oxide.

As described above, it is preferable that the molar ratio between carbonate and calcium (CO₃/Ca) be within a range of 0.90 to 0.95. If the amounts of calcium carbonate and calcium oxide are less than the above range, synergic action between the two components will decrease, which leads to difficulty in obtaining satisfactory antimold/antibacterial effects.

It can be confirmed by scanning electron microscope that the antimold/antibacterial agent of the present invention consisting of baked shell powder is a porous body where the structure of the shell is maintained and fine particles of calcium oxide are scattered inside. By protectively containing scattered calcium oxide inside the porous calcium carbonate body, it is assumed that the agent can exhibit sustainable antimold/antibacterial effects. Therefore, an agent obtained by simply mixing calcium carbonate powder with calcium oxide powder cannot achieve such sustainable antimold/antibacterial effects as the present invention can.

In production of the antimold/antibacterial agent of the present invention, it is preferable that the temperature employed at first-step baking treatment carried out in non-oxidizing atmosphere be in a range of 500 to 600° C. and that the temperature employed at second-step baking treatment carried out in the air atmosphere be in a range of 600 to 900° C. The non-oxidizing atmosphere can be prepared by blocking off the air and oxygen and the atmosphere may be nitrogen atmosphere. In a case where the second-step baking treatment is carried out at 600 to 750° C., the antimold effect can be excellent due to the increased amount of calcium carbonate. On the other hand, in a case where the second-step baking treatment is carried out at 750 to 900° C., the antibacterial effect can be excellent due to the increased amount of calcium oxide.

It is preferable that the average particle size of the antimold/antibacterial agent of the present invention be 40 μm or less, specifically, a preferred range of the particle size is from 0.5 to 10 μm. The baked shell powder having an average particle size of 0.5 to 10 μm has a BET specific surface area of 20 to 30 m²/g, as calculated from adsorption of nitrogen gas at liquid nitrogen temperature. As compared with a specific surface area, generally ten-odd m²/g or so, of powder baked in the air atmosphere, the antimold/antibacterial agent comprising the baked shell powder according to the present invention has a larger specific surface area than those of conventional shell powder agents and therefore, more excellent antimold/antibacterial effects can be achieved.

The main ingredient in a baked shell powder prepared by subjecting scallop shells and the like to single-step baking-treatment at 900° C. or higher in the air atmosphere is calcium oxide powder, which has an antimold effect. The effects, however, disappears in quite a short period of time and the lasting property is inferior to that of the antimold/antibacterial agent of the present invention.

By blending the antimold agent powder into a synthetic resin composite material such as FRP or a synthetic rubber such as silicon rubber or SBR, remarkable antimold/antibacterial effects can be exhibited for a long period of time.

### BRIEF EXPLANATION OF DRAWINGS

FIG. 1 is a powder X-ray diffraction pattern showing ingredients of the baked shell powder of Example 1.

FIG. 2 is a scanning electron micrograph (magnification×2000) showing a cellular structure state of the baked shell powder of Example 1.

FIG. 3 is a scanning electron micrograph (magnification×15.0K) showing a cellular structure state of the baked shell powder of Example 1.

FIG. 4 is a powder X-ray diffraction pattern showing ingredients of the baked shell powder of Example 5.

FIG. 5 is a scanning electron micrograph (magnification×15.0K) showing a cellular structure state of the baked shell powder of Example 5.

### BEST MODE FOR CARRYING OUT THE INVENTION

An antimold/antibacterial agent, comprising inorganic composite baked powder having a structure where a small amount of calcium oxide is contained inside a porous body of calcium carbonate, which agent is obtained by subjecting shells to washing, drying and crushing treatments and then baking the crushed shells first at a low temperature in non-oxidizing atmosphere and secondly at a medium temperature in the air atmosphere, followed by pulverization.

Examples of natural shell used in the present invention include scallop, oyster, surf clam, abalone, blue mussel, little clam and clam. Generally, natural shell is a inorganic/organic composite material which has a lamellar structure where calcium carbonate layer and protein layer such as collagen contained in a small amount are alternately stacked to form a laminate. The crystal shape of calcium carbonate is calcite, aragonite or a mixture thereof. Although natural shell generally contains metal ions such as iron or aluminum, the content of metal ions in natural shell is smaller than that in natural lime stone.

Preferred among the above-described natural shells used in the present invention is scallop shell. Generally, scallop shell consists of calcite-type calcium carbonate. Biologically, scallop is greatly different from other shellfish. That is, scallops swim freely in the sea as if they were sailing, inhaling sea water then exhaling it in a gush while opening and closing the shells. For this, scallop's ligament is large and its shell has a significant strength in spite of its relatively light weight and thinness. The shell structure has an inner surface where calcite-type calcium carbonate fine particles are aligned to form a leaf-like structure and inside the shell, calcite-type calcium carbonate forms a plate-like laminated structure where thin crystal alignment structures intersect with each other. For this structure, when proteins such as collagen which bond the calcium carbonate particles are burned away through baking treatment, porous calcium carbonate having a relatively large specific surface area can be prepared.

Moreover, in scallop shells, fundamental particle size of calcium carbonate is small as compared with that of natural limestone, and scallop shell is also characterized in that its metal ion content such as iron and aluminum is markedly low. Recently, edible shellfish hauls have been increasing year by year, and among them, hauls of scallops and oysters amount to about 500,000 tons a year. Therefore, the amount of shells disposed of is rapidly increasing and there are many cases where shells are abandoned in piles, which cause odors and water contamination. Effective solution to the problem is keenly demanded. According to the present invention, a large amount of scallop shell waste can be effectively used.

Shells are washed with water, dried and crushed to pieces of about 5-10 mm size. The crushed shells are placed in a ceramic container and introduced into an electric furnace, to thereby conduct two-step baking treatments. There is no particular limitation on the baking apparatus and the material and structure constituting the apparatus. Any baking apparatus may be used as long as it can endure heating to at least 900° C. Apparatuses such as rotary kiln where baking proceeds while stirring or pulverizing the material are not suitable here.

Baking includes a first-step baking conducted in non-oxidizing atmosphere at a low temperature and a second-step baking conducted in the air atmosphere at a medium temperature after the first step.

The non-oxidizing atmosphere is not limited as long as air and oxygen are blocked off and it may be a nitrogen atmosphere. In the two-step baking, it is preferable that the temperature employed at the first-step baking be in a range of 500 to 600° C. and the temperature employed at the second-step baking be in a range of 600 to 900° C. Also, it is preferable that time for the first-step baking be from 2 to 4 hours and that time for the second-step baking be from 1 to 3 hours, and the second-step baking time is preferably as long as, or a little shorter than the first-step baking time. By the first-step baking in non-oxidizing atmosphere at 500 to 600° C., organic substances attached on shell surface and proteins such as collagen contained in shell structure are carbonized. If the first-step baking temperature is lower than 500° C., carbonization of organic substance becomes insufficient. Subsequently, by subjecting the resultant carbide-containing baked shell powder to the second-step baking in the air atmosphere at 600 to 900° C., carbide is burned away and part of calcium carbonate is decomposed to thereby become calcium oxide, whereby a composite body having a structure where a small amount of calcium oxide is contained inside a porous body mainly comprising calcium carbonate is prepared. If the second-step baking temperature is 600 to 750° C., a powder having a relatively large calcium carbonate which contributes to an excellent antimold effect can be obtained. On the other hand, if the second-step baking temperature is 750 to 900° C., a powder having a large calcium carbonate which contributes to an excellent antibacterial effect can be obtained. If the second-step baking temperature is 1000° C. or higher, almost all of calcium carbonate is converted into calcium oxide, which is not preferred.

In the composite body obtained by the above two-step baking treatment, a shell structure remains and the calcium oxide generated inside the calcium carbonate structure is relatively stable and not carbonated immediately, which leads to long-lasting antimold effects. Moreover, the composite body obtained by the above two-step baking treatment where the shell structure is allowed to remain in the porous calcium carbonate in the first step, has a small amount of calcium oxide inside a shell structure and by pulverizing the composite body, a fine powder having a large specific surface area can be obtained.

As described above, in the present invention, a carbide layer is formed by subjecting the shells to the first-step baking in non-oxidizing atmosphere, and then by subjecting the material to the second-step baking in the air atmosphere, the carbide is gradually burned away to thereby cavitate the material to obtain a porous baked substance, which enables production of a fine powder having a large specific surface area when pulverized. Specifically, the baked shell powder in the present invention, which is porous, can become a fine powder having a large specific surface area of 20 to 30 m²/g when pulverized to an average particle size of 0.5 to 10 μm. On the other hand, a conventional baked shell powder obtained by subjecting shells to a single-step treatment in the air atmosphere can achieve a specific surface area of at most ten-odd m²/g even if it is pulverized to an average particle size of 10 μm or less.

In scallop shells, a small amount of protein components and the like, which embraces calcium carbonate particles, is contained. In the first-step baking treatment conducted in non-oxidizing atmosphere, proteins and the like are carbonized to change the color of the shell powder from light gray to gray. Then in the second-step baking treatment conducted in the air atmosphere, the carbide contained in the shells is burned away to thereby change the color of the shells from gray to white. Thus, the present invention does not require any particular kinds of chemicals and can obtain the target composite powder by simple baking treatment. The invention, which produces little waste, requires no post-treatment and is totally eco-friendly, is advantageous. Moreover, by such a two-step baking treatment, not only does pulverization of shells become easier, but also can the specific surface area increase, and the thus-prepared porous substance having a shell structure in it enables production of a fine powder where a small amount of calcium oxide is generated and scattered in the calcium carbonate porous body.

As described above, the baked shell powder of the present invention is a composite body, which is obtained by subjecting shells to two-step baking treatment, in which the first-step baking is conducted in non-oxidizing atmosphere at a low temperature (500 to 600° C. to allow the porous calcium carbonate to keep a shell structure and at the same time to carbonize organic components such as proteins, to thereby prepare a composite precursor powder containing the carbides among calcium carbonate particles, and then the second-step baking is conducted in the air atmosphere at a medium temperature (600 to 900° C.) to burn away the carbides and at the same time oxidize a part of calcium carbonate to convert it into calcium oxide to allow a small amount of the calcium oxide scattered in the porous calcium carbonate. After this two-step baking treatment, the baked shells are pulverized at the last step, to thereby prepare a fine powder having an average particle size of preferably 40 μm or less, specifically 0.5 to 10 μm. As pulverization means, ball mill, roller mill, tube mill, jet mill or the like, which can obtain fine powder, can be employed. In the cooling process after baking and the pulverization process, cares must be taken so as not to prevent bacteria, molds, dirt and dust from being mixed into the baked shell powder. Generally, the smaller the particle size, the more improved the dispersibility of the powder in other solid materials. If the powder is pulverized to too small a particle size, the calcium oxide in the porous body becomes more readily carbonated and in a case where blended into a solid material, sustainability of the antimold effect sometimes decreases. Therefore, the preferred range of the average particle size of the pulverized product is 40 μm or less, the optimal range is 0.5 to 10 μm.

### Example 1

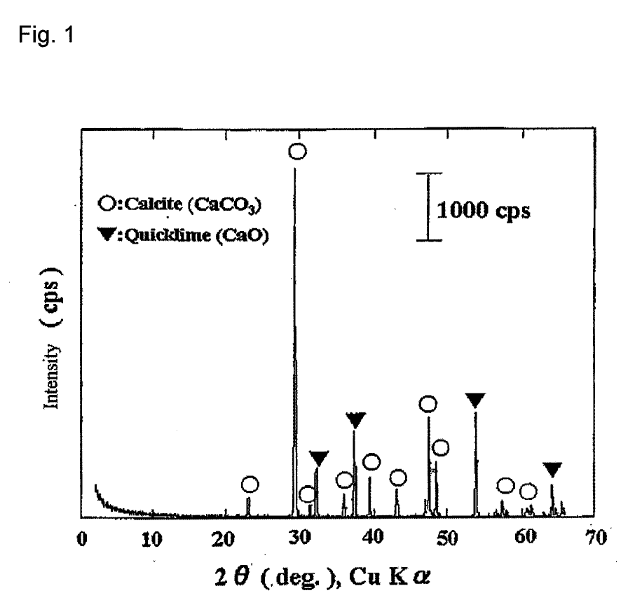

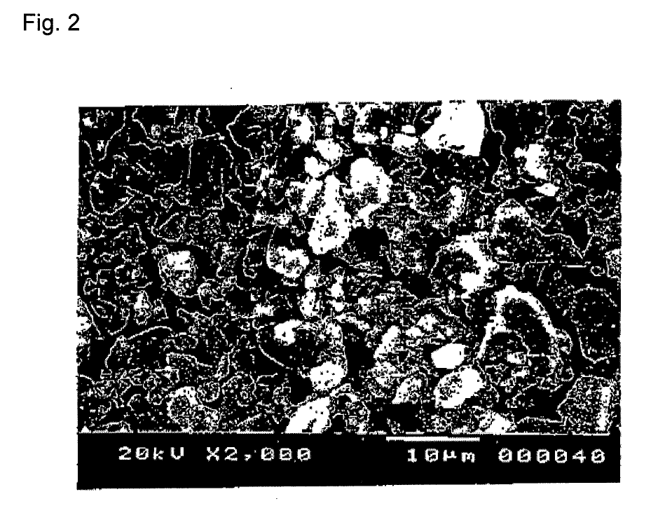

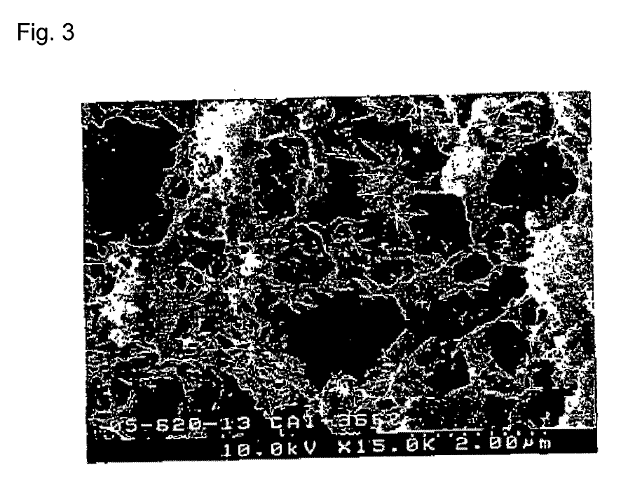

Scallop shells from the Lake Saroma, Hokkaido, Japan, after washed with water and dried, were roughly crushed to an average particle size of 5 mm with a roller mill. The crushed substance was introduced to an electric furnace and subjected to a first-step baking in nitrogen atmosphere at 500° C. for 2 hours. The baked substance was further subjected to second-step baking in the air atmosphere at 700° C. for 2 hours. The baked shells were pulverized by using a jet mill to obtain a baked shell powder having an average particle size of about 5 μm. By analyzing components of the baked powder through X-ray diffraction, it was confirmed that the powder comprised mainly calcite-type calcium carbonate and also contained calcium oxide, as shown in FIG. 1. The BET specific surface area as measured was 27.8 m²/g. Further, the baked shell powder was confirmed to be a porous body where a shell structure remained by electronic microscope observation (FIGS. 2 and 3) Furthermore, the baked shell powder was confirmed to contain Ca²⁺ ion at 40.5% and the mole ratio CO₃/Ca was 0.93. Accordingly, it contained 94.0% by mass calcite-type calcium carbonate porous body, 4.0° by mass calcium oxide and 2.0% by mass other components. Since the baked shell powder is formed of homogenous porous tissues, it was confirmed to be an inorganic composite powder where a small amount of calcium oxide was scattered in the calcite-type calcium carbonate porous body.

### Example 2

Using the scallop shells of Example 1, baked shell powders (Sample No. 1-6) were produced according to production methods shown in Table 1. The baked shell powders were each blended at an amount of 0.3 to 1.0 wt % into FRP material and homogenously dispersed therein to thereby prepare Test Samples.

Mold-resistance test was conducted on the Test Samples. In the test, MS-45 method using 45 types of fungi was employed. The fungi, conditions and evaluation methods employed in the test are shown in Table 2. The test results are shown in Table 3. As shown in Table 3, in the Test Sample containing Sample No. A1 blended therein, no antimold effect was observed. In the Test Sample containing Sample No. A2 baked at a single-step treatment of low temperature, calcium carbonate was contained as its main ingredient and a significant antimold effect was observed at an early stage, but generation of molds was marked at a later stage. Its antimold effect lacked sustainability. In the Test Sample containing Sample No. A3 baked at a single-step treatment of medium temperature, although calcium carbonate and calcium oxide were contained, porosity was damaged, which resulted in small specific surface area. Although the antimold effect was observed until the middle stage of the test period, there was significant generation of molds at the late stage. In the Test Sample containing Sample No. A5 baked at a single-step treatment of high temperature, calcium oxide was contained as its main ingredient and the antimold effect of the same level as that of the Test Sample containing Sample No. A2 was observed. Its antimold effect was observed at the early stage but lacked sustainability. Also, the test sample having blended therein Sample No. A6 consisting of substance baked at low temperature and substance baked at high temperature showed the same results with those of the test sample containing Sample No. A5, and both lacked sustainability of the antimold effects. In contrast, the test sample having blended therein Sample No. A4 of the baked shell powder obtained by conducting first-step baking at low temperature and then second-step baking at medium temperature contained calcium carbonate and calcium oxide and maintained porosity. Its antimold effect was so excellent that no molds were generated from the beginning of the test through the later stage and the effects were long-lasting. Moreover, the FRP materials having this inorganic composite-based antimold agent blended therein showed no deterioration in its original functions.

TABLE 1

| Sample | |
|---|---|
| No. | Baking conditions |
| A1 | Not baked |
| A2 | Single-step baking at a low temperature: Main component |
| | CaCo₃, baking temperature 500-600° C. |
| A3 | Single-step baking at a medium temperature: |
| | Main component CaCo₃ (94% by mass %)-CaO |
| | (4% by mass), baking temperature 600-800° C. |
| | The shell porous body was broken. |
| | Specific surface area: 9.3 m²/g |
| A4 | Two-step baking at a low/medium temperature: |
| | Main component CaCo₃ (94% by mass %)-CaO |
| | (4% by mass), First-step baking temperature: 600 |
| | Second-step baking temperature 700° C. |
| | The shell porous body was maintained. |
| | Specific surface area: 27.8 m²/g |
| | (The same type of baked powder with that of Example 1) |
| A5 | Baking at a high temperature: Main component CaO, |
| | baking temperature 1000° C. |
| A6 | Mixture of shell powder baked at a low temperature (A2) |
| | 94 mass % + shell powder baked at a high temperature (A5) |
| | 4 mass % |

(Note)
A1 to A3 and A5 to A6 are comparative samples and A4 is a sample of the present invention

TABLE 2

[A] Fungi used in the tests
Alternaria alternate (sooty mold)
Aspergillus niger (black mold)
Aspergillus flavus (green mold)
Aspergillus terreus (green mold)
Cladosporium cladosporioides (black mold)
Fusarium moniliforme (red mold)
Penicillium lilacinum (blue mold)
and others (45 species in total)

[B] Test Conditions
Culture media: Inorganic salt agar
Components of the media and the contents

| | | |
|---|---|---|
| 1. KH₂PO₄ | 0.7 | g |
| 2. K₂HPO₄ | 0.7 | g |
| 3. MgSO₄•7H₂O | 0.7 | g |
| 4. NH₄NO₃ | 1.0 | g |
| 5. Nacl | 0.005 | g |
| 6. FeSO₄•7H₂O | 0.002 | g |
| 7. ZnSO₄•7H₂O | 0.002 | g |
| 8. MsSO₄•7H₂O | 0.001 | g |
| 9. agar | 15 | g |
| 10. Pure water | 1000 | ml |

[c] MS-45 evaluation method
Evaluation on growth of fungi on the test sample surface

| | |
|---|---|
| I | No fungi |
| II | growth of 10% or less |
| III | growth of 10 to 30% |
| IV | growth of 30 to 60% |
| V | growth of 60% or more |

TABLE 3

| | | | |
|---|---|---|---|
| Test | | Amount | |
| Sample | baked | added | Test Period (days) |

| No. | powder | (wt %) | 7 | 14 | 21 | 28 |
|---|---|---|---|---|---|---|
| 1 | blank | — | V | — | — | — |
| 2 | A1 | 1.0 | V | — | — | — |
| 3 | A2 | 1.0 | I | II | III | IV |
| 4 | A3 | 0.3 | I | I | II | III |
| | | 1.0 | I | I | I | II |
| 5 | A4 | 0.3 | I | I | I | I |
| | | 1.0 | I | I | I | I |
| 6 | A5 | 0.3 | I | II | III | IV |
| | | 1.0 | I | II | III | III |
| 7 | A6 | 0.3 | I | II | III | IV |
| | | 1.0 | I | II | III | III |

### Example 3

Scallop shells from Mutsu gulf, Aomori, Japan, after washed with water and dried, were roughly crushed to an average particle size of 10 mm with a roller mill. The crushed substance was introduced to an electric furnace and subjected to a first-step baking in nitrogen atmosphere at 500° C. for 2 hours. The baked substance was further subjected to second-step baking in the air atmosphere at 650° C. for 3 hours. The baked shells were pulverized by using a jet mill to obtain a baked shell powder having an average particle size of about 7 μm. By analyzing components of the baked powder through X-ray diffraction, it was confirmed that the powder had almost the same composition as shown in FIG. 1. The BET specific surface area of the baked shell powder was 25.9 m²/g. Further, by electronic microscope observation, the baked shell powder was observed to be a porous body where a shell structure remained and fine particles of calcium oxide were present inside, similarly with FIG. 2. Furthermore, the baked shell powder was confirmed to contain Ca²⁺ ion at 40.5% and the mole ratio CO₃/Ca was 0.93. Accordingly, it was confirmed that the powder was an inorganic composite material which contained 94.0% by mass calcite-type calcium carbonate porous body and 4.0% by mass calcium oxide dispersed therein.

### Example 4

Using the scallop shells of Example 3, baked shell powders (Sample No. B1-6) were produced according to production methods shown in Table 1. The baked shell powders were each blended at an amount of 5 to 10 wt % into synthetic rubber material and homogenously dispersed therein to thereby prepare Test Samples. Mold-resistance test was conducted on the Test Samples. In the test, JIS method using Aureobasidium pullulans was employed. The fungus, conditions and evaluation methods employed in the test are shown in Table 4. The test results are shown in Table 5.

As shown in Table 5, in the Test Sample containing Sample No. B1 blended therein, more living strains were observed than in the blank sample and no antimold effect was observed. In the Test Sample containing Sample No. B2, although the survival rate of the strains was reduced from 78% to 40%, the antimold effect was low and lacked sustainability. In the Test Sample containing Sample No. B3, although the survival rate of the strains was reduced from 26-30% range to 1-6% range and the antimold effect has a significant sustainability, there was still room for improvement. In the Test Samples each containing Sample No. B5 and B6, almost same antimold effects were observed, which were lower than the antimold effect of Test Sample B3. In contrast, the Test Sample having blended therein Sample No. B4 of the baked shell powder obtained by conducting first-step baking at low temperature and then second-step baking at medium temperature showed an excellent antimold effect from the beginning of the test and the survival rate of the strains was in a range of 14 to 20% and at a later stage of the test, it was reduced to 0.02%, which evidenced that the antimold effect was excellent and long-lasting.

TABLE 4
[A] Fungus used in the test
Aureobasidium pullulans
[B] Test Conditions
Culture media: normal bouillon media + standard agar media
[C] JIS-Z-2801evaluation method
Liquid containing strains prepared at 1/500 bouillon was added dropwise
to each Test Sample, tightly adhered to each other by using a film, and
kept at 35° C. Measurement was made on the number of the living strains
present in the liquid on the Test Sample.
[D] Test Sample
Each Test Sample was prepared by blending one of the following 5 types
of powder (average particle size of about 5 μm) into a rubber material
at 5 or 10 wt % and pressing at about 200° C. to thereby form a film.

TABLE 5

| | | Amount | | | | | | |
|---|---|---|---|---|---|---|---|---|
| Sample | baked | added | Test Period(days) | | | | | |
| No. | powder type | (wt %) | initial | 6 | 24 | | 48 | |
| | Blank | — | 500,000 (100) | 430,000 (86) | 330,000 | (66) | 260,000 | (52) |
| B1 | Non-baked | 10 | 500,000 (100) | 450,000 (90) | 450,000 | (90) | 430,000 | (86) |
| | powder(A1) | | | | | | | |
| B2 | Low-temperature | 10 | 500,000 (100) | 390,000 (78) | 310,000 | (62) | 200,000 | (40) |
| | baked powder(A2) | | | | | | | |
| B3 | Medium-temperature | 5 | 500,000 (100) | 180,000 (36) | 90,000 | (18) | 30,000 | (6.0) |
| | baked powder(A3) | | | | | | | |
| | | 10 | 500,000 (100) | 130,000 (26) | 20,000 | (4.0) | 5,000 | (1.0) |
| B4 | Low-temperature | 5 | 500,000 (100) | 100,000 (20) | 30,000 | (6.0) | 110 | (0.02) |
| | Medium-temperature | | | | | | | |
| | Two-step baked | 10 | 500,000 (100) | 70,000 (14) | 1,500 | (0.3) | 110 | (0.02) |
| | powder(A4) | | | | | | | |
| B5 | High-temperature | 5 | 500,000 (100) | 200,000 (40) | 110,000 | (22) | 100000 | (20) |
| | Baked powder(A5) | | | | | | | |
| | | 10 | 500,000 (100) | 160,000 (32) | 60,000 | (12) | 60,000 | (12) |
| B6 | Mixture of | 5 | 500,000□ (100) | 220,000 (44) | 120,000 | (24) | 110,000 | (22) |
| | low-temperature | | | | | | | |
| | baked powder & | 10 | 500,000 (100) | 150,000 (30) | 70,000 | (14) | 50,000 | (10) |
| | high-temperature | | | | | | | |
| | baked powder (A6) | | | | | | | |

(Note)
The numbers in the parentheses represent survival rates (%), assuming that the initial number of the strains is 100 in each test.
The components, specific surface area values and the like of baked powders are the same with those in Table 1.
The symbols (A1-A6) in the parentheses following each of the baked powder type represent the corresponding baking method in Table 1.

### Example

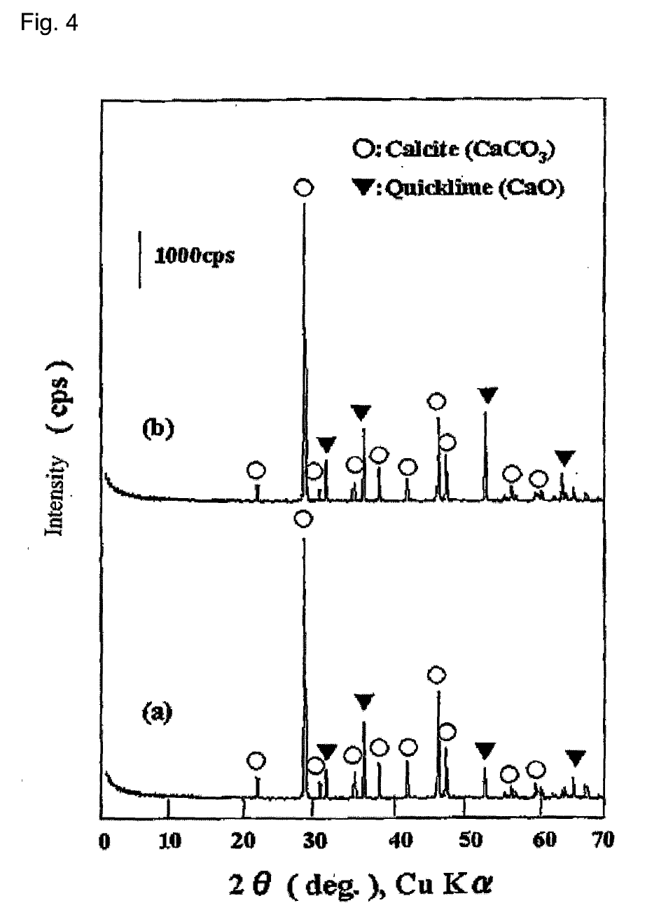

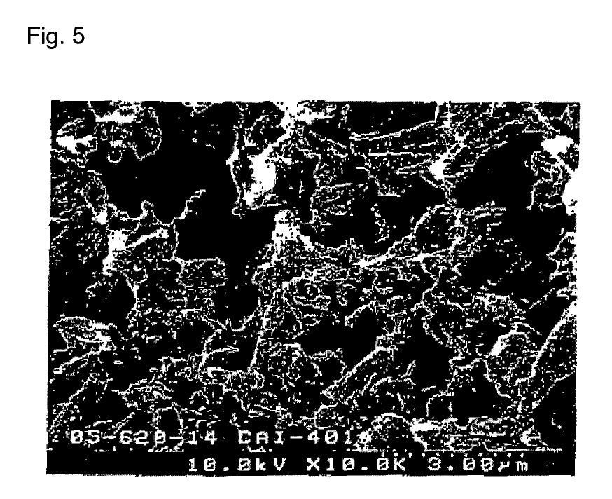

Scallop shells from the Lake Saroma, Hokkaido, Japan, after washed with water and dried, were roughly crushed to an average particle size of 5 mm with a roller mill. The crushed substance was introduced to an electric furnace and subjected to a first-step baking in nitrogen atmosphere at 500° C. for 2 hours. The baked substance was further subjected to second-step baking in the air atmosphere at 850° C. for 2 hours. The baked shells were pulverized by using a jet mill to obtain a baked shell powder having average particle sizes of about 5 μm and about 30 μm. By analyzing components of the baked powder through X-ray diffraction, it was confirmed that the powder comprised mainly calcite-type calcium carbonate and also contained calcium oxide, as shown in FIG. 4(b). As compared with the powder (FIG. 4a) baked at 750° C. in the second step baking, the peak of calcium oxide was more prominent, which shows that more calcium oxide was contained. Further, the baked shell powder were confirmed to be a porous body where a shell structure remained and fine particles of calcium oxide were present, by electronic microscope observation (FIG. 5) Furthermore, by chemical analysis, the baked shell powder was confirmed to contain Ca²⁺ ion at 41.4% and the mole ratio CO₃/Ca was 0.88. Accordingly, it was confirmed that the powder was an inorganic composite material which contained 91.0% by mass calcite-type calcium carbonate porous body and 6.1% by mass calcium oxide dispersed therein.

### INDUSTRIAL APPLICABILITY

The antimold/antibacterial agent of the present invention comprises a baked shell powder obtained by washing shells with water, drying, roughly crushing, subjecting the resultant crushed shells to low-temperature baking treatment in non-oxidizing atmosphere at 500 to 600° C., and then further to medium-temperature baking treatment in the air atmosphere at 600 to 900° C., followed by pulverization to preferably an average particle size of 40 μm or less. By conducting the above two-step baking treatment, the shells can become an inorganic composite baked powder in which porous calcite-type calcium carbonate contains a small amount of calcium oxide scattered therein. Its porosity and coexistence of calcium carbonate and calcium oxide act synergically to thereby exhibit long-lasting antimold/antibacterial effects. Moreover, the agent, which consists of natural resources, is safe and can be used for protection of foods and products of other fields.

1. An antimold/antibacterial agent, comprising inorganic composite baked powder having a structure where a small amount of calcium oxide is contained inside a porous body of calcium carbonate, which agent is obtained by subjecting shells to washing with water, drying and crushing treatments and then baking the crushed shells first at a low temperature in non-oxidizing atmosphere and secondly at a medium temperature in the air atmosphere, followed by pulverization.

2. The antimold/antibacterial agent according to claim 1, wherein the molar ratio of carbonate to calcium (CO₃/Ca) is in a range of 0.90 to 0.95.

3. The antimold/antibacterial agent according to claim 1, wherein the temperature employed at first-step baking treatment carried out in non-oxidizing atmosphere is in a range of 500 to 600° C. and the temperature employed at second-step baking treatment carried out in the air atmosphere is in a range of 600 to 900° C.

4. The antimold/antibacterial agent according to claim 1, which is obtained by subjecting the shells to washing, drying and crushing treatments and then baking the crushed shells first at a low temperature of 500 to 600° C. in non-oxidizing atmosphere and secondly at a medium temperature of 600 to 900° C. in the air atmosphere, followed by pulverization of the crushed shells to thereby obtain a fine powder having an average particle size of 40 μm or less.

5. The antimold/antibacterial agent according to claim 1, wherein the particle size is within a range of 0.5 to 10 μm and the specific surface area is within a range of 10 to 30 m²/g.

6. The antimold/antibacterial agent according to claim 1, wherein the shell is one or more kinds selected from a group consisting of scallop, oyster, surf clam, abalone, blue mussel, little clam and clam.
